(19) United States
(12) Patent Application Publication
(10) Pub. No.: US 2018/0306911 A1
(43) Pub. Date: Oct. 25, 2018

(54) METHOD AND SYSTEM FOR RESOLVING RANGE AMBIGUITY

(71) Applicant: QAMCOM TECHNOLOGY AB, Gothenburg (SE)

(72) Inventors: Thomas PERNSTÅL, Åsa (SE); Gary SMITH JONFORSEN, Askim (SE)

(73) Assignee: QAMCOM TECHNOLOGY AB, Gothenburg (SE)

(21) Appl. No.: 15/769,862

(22) PCT Filed: Oct. 16, 2016
(86) PCT No.: PCT/SE2016/050999

§ 371 Date: Apr. 20, 2018

(30) Foreign Application Priority Data
Oct. 21, 2015 (SE) 1530164-1

(51) Int. Cl. G01S 13/58; G01S 7/35

(52) U.S. Cl. CPC G01S 13/584; G01S 13/931; G01S 7/354

(57) ABSTRACT

A system for resolving range ambiguity includes
a wave generator a modulator for applying a digital signature to a continuous wave to generate a digitally-signed continuous wave,
a transmitter for emitting the digitally-signed continuous wave from the ranging system as interrogating radiation towards an object,
a receiver for receiving a portion of the interrogating radiation after reflection from the object,
a correlator for correlating the portion of the interrogating radiation against the emitted digitally signed continuous wave according to the digital signature,
a processor for determining from correlation in the correlator an elapsed time period between emitting the interrogating radiation and receiving the portion of the interrogating radiation after reflection from the object, wherein the processor calculates a range of the object from the transmitter by employing space-time adaptive processing and to determine a velocity of the object from correlation in the correlator using Doppler detection.

### TECHNICAL FIELD

The present disclosure relates to ranging systems, for example implemented as radar apparatus, that are operable to emit interrogating radiation to a region of interest (ROI) and to receive corresponding reflected radiation from the region of interest (ROI) for determining ranging data pertaining to one or more objects present in the region of interest (ROI). Moreover, the present disclosure concerns methods of operating aforesaid ranging systems, for example to enable the aforesaid radar systems to resolve range ambiguity. Furthermore, the present disclosure is concerned with computer program products comprising a non-transitory computer-readable storage medium having computer-readable instructions stored thereon, the computer-readable instructions being executable by a computerized device comprising processing hardware to execute aforesaid methods.

### BACKGROUND

In overview, ranging systems, such as radar apparatus, are well known and include an emitting arrangement for emitting interrogating radiation, for example electromagnetic radiation, towards a region of interest (ROI) and a receiving arrangement for receiving a portion of the emitted interrogating radiation that is reflected back from the region of interest (ROI). Optionally, the ranging system is implementable by using sonar and lidar (“light direction and ranging”) apparatus that use sound waves and optical laser radiation, respectively, for ranging, namely for determining a distance from one location or position to another location or position. In such ranging systems, a conventional approach for obtaining range estimates involves employing mutually different frequency sweeps in respect of the emitted interrogating radiation, namely by using mutually different frequency modulated chirps.

In a Chinese patent application CN101089653 (inventor: MU LI; applicant: XI AN UNIV OF TECHNOLOGY), there is described a short-range frequency modulated continuous wave (FMCW) radar jamming method. Depending on operating conditions and radar designs, there is employed in operation a pseudo-random code, wherein mutually different radar working areas are assigned mutually different pseudo-random codes.

In another Chinese patent application CN103592645, there is described a phase modulation carried out on carrier waves by using staggered pseudo-random codes. The pseudo-random codes are alternately used, wherein a velocity ambiguity computation is carried out by using target velocity remainders obtained through double measurement, and thus a real velocity measurement of a target can be determined. Such a velocity ambiguity computation method ensures that distance measurement within a given radar measuring range is unambiguous. Moreover, a capacity of a given radar system for detecting a target at a given distance can be improved through distance subsection target detection. Moreover, the frequency of false alarms caused by nearby ground clutter and nearby sea clutter can be reduced through a distance-and-sensitivity control method, and a capacity of the radar system for detecting low-speed targets in a complex environment is thereby improved.

In yet another United kingdom patent application GB2305323, there is described a continuous wave ranging system that comprises a modulator for modulating an radio frequency carrier signal in accordance with a pseudo-random code, a transmitting antenna for radiating the signal towards a target, a receiving antenna and receiver for detecting a portion of the signal reflected from the target, and a correlator for correlating the detected signal with the transmitted code with a selected phase shift corresponding to a current given range gate to be tested, whereby the range of the target from the system is determined by employing filtering means for filtering from the output of the correlator those range gate amplitudes that vary with a frequency that is less than a predetermined value to discriminate against transmitter breakthrough and local reflections.

In yet another United Kingdom patent application GB2504251, there is described a digitally coded radar, in which a frequency ramp carrier wave generator is modulated by a code generator with a code comprising a sequence of digits. Ambiguities resulting from a range determination based on demodulating at a demodulator of the digitally coded radar are resolved by demodulating a resulting signal at mixers with the frequency ramp carrier to produce an independent determination of range. Thus, a relatively short code may be used without encountering range ambiguity.

From the foregoing, it will be appreciated that known radar systems employ different frequency sweeps for a given transmitted interrogating signal, namely for frequency-modulated chirps, based upon using pseudo-random codes. However, using such an approach requires spreading transmitted power of the transmitted interrogating signal over a relatively large bandwidth corresponding to the frequency modulated chirps. Moreover, such an approach requires a higher bandwidth to be employed, that potentially demands higher performance from a phase lock loop (PLL) employed, namely for satisfying chirp linearity requirements. Therefore, the approach requires a high performance PLL to be employed in a ranging system in order to obtain the ranging data in a suitable manner. Furthermore, if a lower performance PLL were employed, or any ambiguity in the performance of the PLL were to occur, for example due to accommodating a higher bandwidth, the ranging data could be potentially influenced. There is therefore a need to improve known ranging system to resolve their ranging ambiguity, for example ranging ambiguity that arises for various reasons in the foregoing examples of known radar systems.

### SUMMARY

The present disclosure seeks to provide a method of resolving range ambiguity for a ranging system; specifically, the present disclosure seeks to provide a method of resolving range ambiguity for a ranging system, wherein the method comprises applying a frequency-coded continuous wave as interrogating radiation, to be emitted by the ranging system, for resolving range ambiguity.

The present disclosure also seeks to provide a system for resolving range ambiguity; specifically, the present disclosure seeks to provide a system for resolving range ambiguity, wherein the system is operable to apply frequency-coded continuous wave as interrogating radiation, for resolving range ambiguity.

According to a first aspect, there is provided a method of resolving range ambiguity in a ranging system, characterized in that the method comprises:
(i) generating a continuous wave;
(ii) applying a digital signature to the continuous wave to generate a digitally-signed continuous wave;
(iii) emitting the digitally-signed continuous wave from a transmitter of the ranging system as interrogating radiation towards an object;
(iv) receiving at a receiver a portion of the interrogating radiation after reflection from the object;
(v) correlating the portion of the interrogating radiation against the emitted digitally signed continuous wave according to the digital signature;
(vi) determining from correlation in (v) an elapsed time period between emitting the interrogating radiation and receiving the portion of the interrogating radiation after reflection from the object;
(vii) from the elapsed time period and a frequency of the continuous wave, calculating a range of the object from the transmitter, employing space-time adaptive processing; and
(viii) determining a velocity of the object from correlation in (v) using Doppler detection.

The invention is of advantage in that the method requires spreading transmitted power over a relatively smaller bandwidth by employing the digitally-signed continuous wave, for example implemented as a frequency step-wise coded continuous wave.

As a result, it is feasible to relax performance of a phase locked loop (PLL) employed in the ranging system, due to a relatively smaller bandwidth that is employed in operation, and to avoid range ambiguity, for example which potentially arises due the performance limitations of the PLL.

It will be appreciated that if a single target is included in a clutter-free environment, a correlator of a ranging system is able, with relative ease, to estimate a range of the single target and its associated Doppler characteristics. However, if the aforementioned environment is a dense target scenario, or there are a plurality of targets obscured by clutter, for example various forms of round reflection of radar radiation, then a processor capable of providing a sophisticated tracking framework is advantageously employed in embodiments of the present disclosure.

Optionally, in the method, applying the digital signature further comprises applying a frequency shift waveform.

Optionally, in the method, applying the digital signature further comprises applying discrete frequency modulation steps. More optionally, in the method, applying the digital signature further comprises applying frequency pulses in a frequency range of 76 GHz to 76.5 GHz.

Optionally, in the method, applying the digital signature further comprises applying frequency pulses exhibiting individual frequencies.

Optionally, in the method, applying the digital signature further comprises applying a frequency shift waveform exhibiting non-linearity.

Optionally, in the method, applying the digital signature further comprises forming a specific code.

Optionally, the method includes at least one of:
(a) adaptively modifying a length of the digital signature, for example by modifying a total number of step-wise frequency changes employed for the digital signature when employed in the ranging system;
(b) adaptively modifying magnitudes of frequency changes for step-wise frequency changes associated with the digital signature, for example by scaling the frequency changes from one step to another in the digital signature when employed in the ranging system; and
(c) adaptively reversing an order of frequency changes of the digital signature employed in the ranging system.

Optionally, in the method, correlating further comprises correlating over an entire pulse train of the emitted digitally signed continuous wave.

According to a second aspect, there is provided a system for resolving range ambiguity, characterized in that the system comprises:
(i) a wave generator for generating a continuous wave, and a modulator for applying a digital signature to the continuous wave to generate a digitally-signed continuous wave;
(ii) a transmitter for emitting the digitally-signed continuous wave from the ranging system as interrogating radiation towards an object;
(iii) a receiver for receiving a portion of the interrogating radiation after reflection from the object;
(iv) a correlator for correlating the portion of the interrogating radiation against the emitted digitally signed continuous wave according to the digital signature;
(vi) a processor for determining from correlation in the correlator an elapsed time period between emitting the interrogating radiation and receiving the portion of the interrogating radiation after reflection from the object; wherein the processor, from the elapsed time period and a frequency of the continuous wave, is operable to calculate a range of the object from the transmitter by employing space-time adaptive processing; and to determine a velocity of the object from correlation in the correlator using Doppler detection.

Optionally, the processor is operable to compute the elapsed time period.

Optionally, in the system, the modulator is further operable to apply a frequency shift waveform.

Optionally, in the system, the modulator is further operable to apply discrete frequency modulation steps. More optionally, in the system, the modulator is further operable to apply frequency pulses in a frequency range of 76 GHz to 76.5 GHz.

Optionally, in the system, the modulator is further operable to apply frequency pulses exhibiting individual frequencies.

Optionally, in the system, the modulator is further operable to apply a frequency shift waveform exhibiting non-linearity.

Optionally, in the system, the modulator is further operable to form a specific code.

Optionally, in the system, the correlator is further operable to correlate over an entire pulse train of the emitted digitally signed continuous wave.

According to a third aspect, there is provided a computer program products comprising a non-transitory computer-readable storage medium having computer-readable instructions stored thereon, the computer-readable instructions being executable by a computerized device comprising processing hardware to execute a method pursuant to the first aspect.

It will be appreciated that features of the aspects of the present disclosure are susceptible to being combined in various combinations without departing from the scope of the invention as defined by the appended claims.

### DESCRIPTION OF THE DIAGRAMS

Embodiments of the present disclosure will now be described, by way of example only, with reference to the following diagrams wherein:

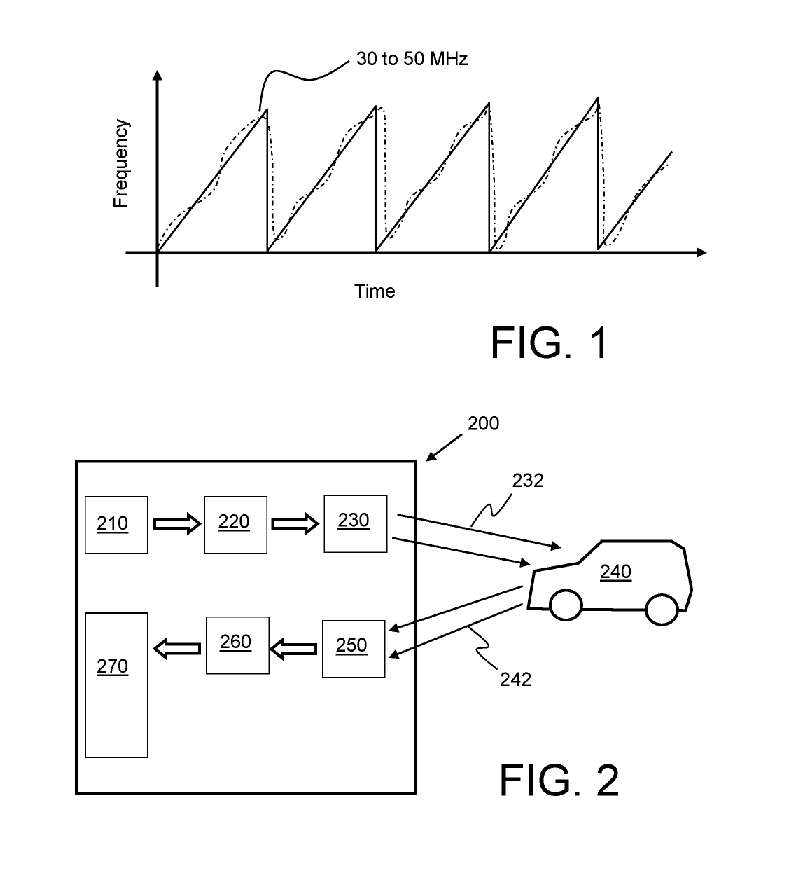

FIG. 1 is a graph illustrating a rate of change in frequency as a function of time for chirping of conventional interrogating radiation;

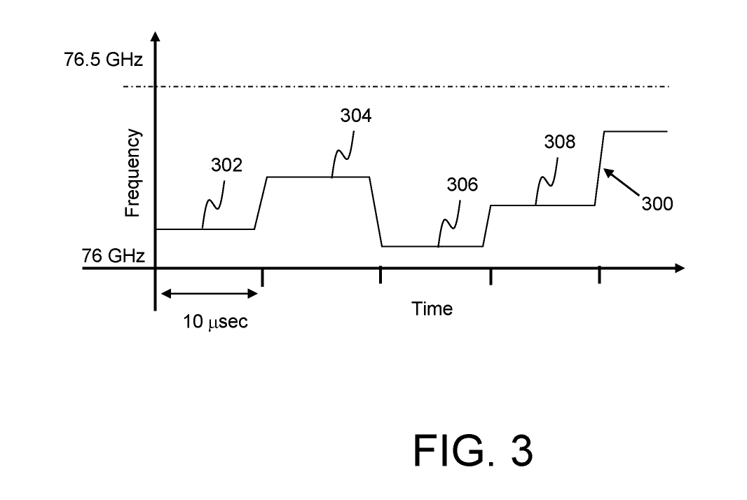

FIG. 2 is a schematic illustration of a ranging system pursuant to the present disclosure;

FIG. 3 is a graph illustrating signature frequency modulation of a continuous wave signal for providing interrogating radiation pursuant to the present disclosure; and

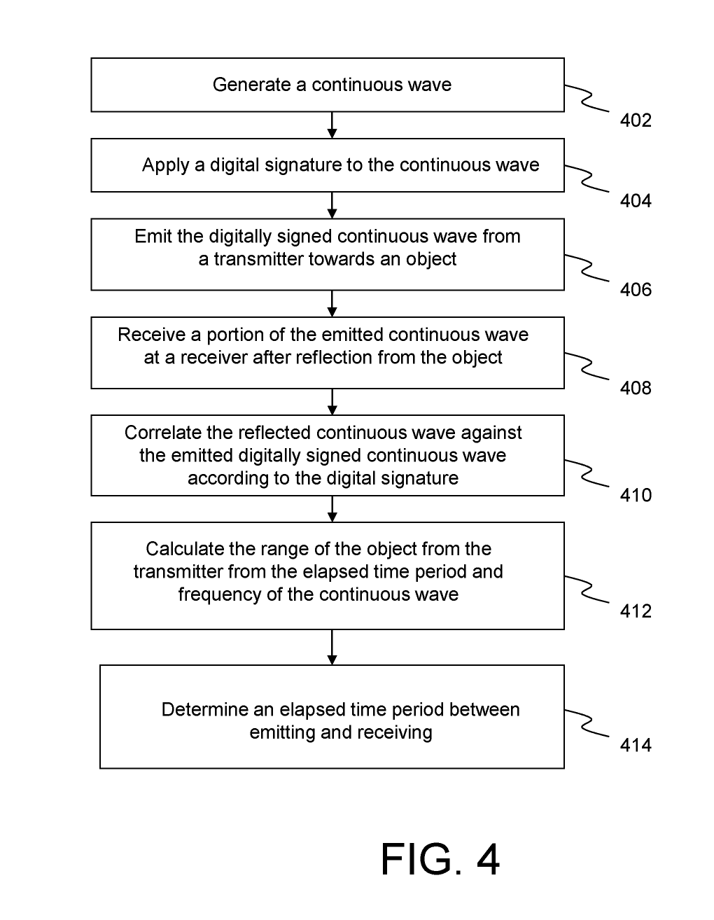

FIG. 4 is a flow chart of steps of a method of resolving range ambiguity of a ranging system.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS

According to a first aspect, there is provided a method of resolving range ambiguity in a ranging system, characterized in that the method comprises:
(i) generating a continuous wave;
(ii) applying a digital signature to the continuous wave to generate a digitally-signed continuous wave;
(iii) emitting the digitally-signed continuous wave from a transmitter of the ranging system as interrogating radiation towards an object;
(iv) receiving at a receiver a portion of the interrogating radiation after reflection from the object;
(v) correlating the portion of the interrogating radiation against the emitted digitally signed continuous wave according to the digital signature;
(vi) determining from correlation in (v) an elapsed time period between emitting the interrogating radiation and receiving the portion of the interrogating radiation after reflection from the object;
(vii) from the elapsed time period and a frequency of the continuous wave, calculating a range of the object from the transmitter, employing space-time adaptive processing; and
(viii) determining a velocity of the object from correlation in (v) using Doppler detection.

The method is of advantage in that the method requires spreading transmitted power over a relatively smaller bandwidth by employing the digitally-signed continuous wave, for example implemented as a frequency step-wise coded continuous wave.

As a result, it is feasible to relax performance of a phase locked loop (PLL) employed in the ranging system, due to a relatively smaller bandwidth that is employed in operation, and to avoid range ambiguity, for example which potentially arises due the performance limitations of the PLL.

It will be appreciated that if a single target is included in a clutter-free environment, a correlator of a ranging system is able, with relative ease, to estimate a range of the single target and its associated Doppler characteristics. However, if the aforementioned environment is a dense target scenario, or there are a plurality of targets obscured by clutter, for example various forms of round reflection of radar radiation, then a processor capable of providing a sophisticated tracking framework is advantageously employed in embodiments of the present disclosure.

Optionally, in the method, applying the digital signature further comprises applying a frequency shift waveform.

Optionally, in the method, applying the digital signature further comprises applying discrete frequency modulation steps. More optionally, in the method, applying the digital signature further comprises applying frequency pulses in a frequency range of 76 GHz to 76.5 GHz.

Optionally, in the method, applying the digital signature further comprises applying frequency pulses exhibiting individual frequencies.

Optionally, in the method, applying the digital signature further comprises applying a frequency shift waveform exhibiting non-linearity.

Optionally, in the method, applying the digital signature further comprises forming a specific code.

Optionally, in the method, correlating further comprises correlating over an entire pulse train of the emitted digitally signed continuous wave.

Optionally, the method includes at least one of:
(a) adaptively modifying a length of the digital signature, for example by modifying a total number of step-wise frequency changes employed for the digital signature when employed in the ranging system;
(b) adaptively modifying magnitudes of frequency changes for step-wise frequency changes associated with the digital signature, for example by scaling the frequency changes from one step to another in the digital signature when employed in the ranging system; and
(c) adaptively reversing an order of frequency changes of the digital signature employed in the ranging system.

According to a second aspect, there is provided a system for resolving range ambiguity, characterized in that the system comprises:
(i) a wave generator for generating a continuous wave, and a modulator for applying a digital signature to the continuous wave to generate a digitally-signed continuous wave;
(ii) a transmitter for emitting the digitally-signed continuous wave from the ranging system as interrogating radiation towards an object;
(iii) a receiver for receiving a portion of the interrogating radiation after reflection from the object;
(iv) a correlator for correlating the portion of the interrogating radiation against the emitted digitally signed continuous wave according to the digital signature;
(vi) a processor for determining from correlation in the correlator an elapsed time period between emitting the interrogating radiation and receiving the portion of the interrogating radiation after reflection from the object; wherein the processor, from the elapsed time period and a frequency of the continuous wave, is operable to calculate a range of the object from the transmitter by employing space-time adaptive processing; and to determine a velocity of the object from correlation in the correlator using Doppler detection.

Optionally, the processor is operable to compute the elapsed time period.

Optionally, in the system, the modulator is further operable to apply a frequency shift waveform.

Optionally, in the system, the modulator is further operable to apply discrete frequency modulation steps. More optionally, in the system, the modulator is further operable to apply frequency pulses in a frequency range of 76 GHz to 76.5 GHz.

Optionally, in the system, the modulator is further operable to apply frequency pulses exhibiting individual frequencies.

Optionally, in the system, the modulator is further operable to apply a frequency shift waveform exhibiting non-linearity.

Optionally, in the system, the modulator is further operable to form a specific code.

Optionally, in the system, the correlator is further operable to correlate over an entire pulse train of the emitted digitally signed continuous wave.

According to a third aspect, there is provided a computer program products comprising a non-transitory computer-readable storage medium having computer-readable instructions stored thereon, the computer-readable instructions being executable by a computerized device comprising processing hardware to execute a method pursuant to the first aspect.

In overview, referring to FIG. 1, embodiments of the present disclosure are concerned with a ranging system, for example the ranging system is implemented as a radar system, a LIDAR system or an acoustic ranging system. The ranging system is operable to emit interrogating radiation into a region of interest (ROI), and to receive a portion of the interrogating radiation that is reflected from one or more objects within the region of interest (ROI), wherein the portion of the interrogating radiation that is reflected is processed for computing range information pertaining to the one or more objects.

Referring to FIG. 1, there is shown a graph illustrating a rate of change in frequency as a function of time for chirping as employed in conventional interrogating radiation, for example interrogating electromagnetic radiation emitted from a radar system into a region of interest (ROI). As shown in FIG. 1, the conventional interrogating radiation includes mutually different frequency sweeps. For example, the conventional interrogating radiation is shown to sweep linearly in frequency between 30 MHz and 50 MHz. Moreover, the conventional interrogating radiation typically includes about 100 cycles of chirp signals, with a chirp period in a range of 10 μsec to 100 μsec. In other words, the conventional interrogating radiation optionally includes circa 100 cycles of chirp signals beginning at a frequency of 30 MHz and ending at a frequency of 50 MHz, and such frequency sweep optionally happens in a chirp period in a range of 10 μsec to 100 μsec. In such circumstances, the conventional radar system requires a high performance PLL (“phase looked loop”) to be employed in order to obtain suitable accurate ranging data. Moreover, the high performance PLL is required for managing the conventional interrogating radiation, namely for managing chirp signals in a range of about 30 MHz to 50 Mhz, to be emitted, and received by the conventional radar system. Therefore, use of a low-performance PLL, or any ambiguity in the performance of the PLL due to a larger frequency bandwidth, potentially influences the ranging data that is computed.

Referring next to FIG. 2, embodiments of the present disclosure are concerned with a ranging system, indicated generally by 200, that is operable to resolve range ambiguity as aforementioned. In an example, the ranging system 200 is a radar system; however, it will be appreciated that embodiments of the present disclosure can be employed in LIDAR and acoustic ranging systems, although such LIDAR and acoustic ranging system operate in a different frequency regime than that employed in a radar system employing emission and reception of electromagnetic radiation whose principal frequency is in an order of GHz. The ranging system 200 employs in operation a wave generator 210 that is operable to generate a continuous wave interrogating signal. The wave generator 210 is optionally a magnetron, or any suitable electronic assembly, that is operable to generate continuous electromagnetic radiation having a frequency in a range of 50 GHz to 150 GHz, and more optionally having a frequency of about 77 GHz. The ranging system 200 further employs in operation a modulator 220 that is operable to apply a digital signature to the continuous wave; application of the digital signature will be elucidated in greater detail hereinafter. The ranging system 200 also employs in operation a transmitter 230 which is operable to emit a digitally signed continuous wave 232 towards an object 240 in a region of interest (ROI). The ranging system 200 further employs in operation a receiver 250 that is operable to receive a portion of the emitted continuous wave after reflection from the object 240, namely a reflected continuous wave 242.

In an example, the transmitter 230 and the receiver 250 include an array of antenna elements for emitting the digitally signed continuous wave 232, namely the interrogating radiation, and receiving the reflected continuous wave 242, respectively. Optionally, a same array of antenna elements are optionally employed both for emitting the digitally signed continuous wave 232 and also for receiving the reflected continuous wave 242.

The ranging system 200 also employs in operation a correlator 260 that is operable to correlate the reflected continuous wave 242 against the emitted digitally signed continuous wave 232 according to the digital signature. The ranging system 200 further employs in operation a processor 270 that is operable to determine an elapsed time period between emitting and receiving and, from the elapsed time period and a frequency of the continuous wave, to calculate the range of the object 240 from the transmitter 230.

In the present disclosure, the digitally signed continuous wave 232, emitted by the transmitter 230, is mutually different from the conventional interrogating radiation, as shown in FIG. 1, namely employing chirp signals in a frequency range of about 30 MHz to 50 MHz, for example 30.0 MHz to 50.0 MHz. Specifically, the digitally signed continuous wave 232, as interrogating radiation, is associated with a pulse train having pulses exhibiting individual frequencies, instead of sweeping frequencies, which are optionally linear or exponential as a function of time, of conventional chirp signals. In other words, specifically, the digitally signed continuous wave 232, as interrogating radiation, is chirped in frequency in a frequency discrete stepwise manner.

As aforementioned, the modulator 220 is operable to apply the digital signature to the continuous wave. Specifically, the modulator 220 of the present disclosure is operable to apply the digital signature to the continuous wave generated by the wave generator 210, such that the transmitter 230 emits the digitally signed continuous wave 232 as interrogating radiation. In an example, the modulator 220 is operable to apply a frequency-shift waveform, namely constituting the digitally signed continuous wave 232 as the interrogating radiation. Moreover, the modulator 220 is optionally adapted to apply discrete frequency modulation steps in order to achieve the frequency-shift waveform.

As aforementioned, the digitally signed continuous wave 232, as interrogating radiation, is associated with the pulse train having pulses exhibiting individual frequencies, namely temporally changed in frequency step-wise manner. In an example, the modulator 220 is operable to apply frequency pulses exhibiting individual frequencies. Moreover, the modulator 220 is also operable to apply a frequency-shift waveform exhibiting non-linearity. Furthermore, the modulator 220 is further operable to form a specific code. The specific code is associated with the individual frequencies of the pulse train that constitute the digitally signed continuous wave 232.

In an embodiment, the modulator 220 is optionally operatively coupled to the processor 270 for applying the digital signature to the continuous wave. The processor 270 is optionally advantageously implemented as one or more reduced instruction set computers (RISC), or an array of such RISC. The processor 270 is optionally operable to execute one or more software products, including computer instructions, which enable the digital signature to be applied to the continuous wave.

As aforementioned, the correlator 260 is operable to correlate the reflected continuous wave 242 against the emitted digitally signed continuous wave 232 according to the digital signature. Specifically, the correlator 260 is operable to correlate over an entire pulse train of the emitted digitally signed continuous wave 232 against the reflected continuous wave 242 according to the digital signature. For example, the correlator 260 optionally employs a match filter, which is operable to correlate according to the digital signature, over the entire pulse train. Thereafter, the processor 270 is operable to determine the elapsed time between emitting and receiving and, from the elapsed time and frequency of the continuous wave, calculate the range of the object 240 from the transmitter 230. As mentioned above, the processor 270 is optionally a computer and is operable to execute one or more software products, for example for implementing one or more algorithms. Therefore the processor 270 is optionally operable to execute algorithms capable of processing an elapsed time period and a frequency of the continuous wave to calculate the range of the object 240 from the transmitter 230.

Optionally, alternatively, the correlator 260 is operable to correlate temporal sub-portions of the reflected continuous wave 242 against sub-portions of the emitted digitally signed continuous wave 232 according to the digital signature. Specifically, the correlator 260 is operable to correlate over sub-portions of an entire pulse train of the emitted digitally signed continuous wave 232 against sub-portions of the reflected continuous wave 242 according to the digital signature; such an approach reduces an amount of computing power required to perform correlation for each sub-portion, such that grouped consecutive correlation of the sub-portions is used for indicating that a correlation match has been identified. Such an approach potentially reduces computing effort required, enabling embodiments of the present disclosure to be implemented in a more cost-effective manner, for example important in cost-sensitive applications such as vehicle-mounted automatic braking and autonomous steering apparatus.

Referring next to FIG. 3, there is provided an illustration of a graph showing a signature frequency modulation of a continuous wave signal for providing interrogating radiation pursuant to the present disclosure. Specifically, in FIG. 3, there is illustrated a portion of a pulse train 300 corresponding to a digitally signed continuous wave, such as the digitally signed continuous wave 232, constituting the interrogating radiation to be emitted by the ranging system 200, as shown in FIG. 2. As shown, the pulse train 300 includes a plurality of pulses, such as pulses 302, 304, 306, 308, exhibiting individual frequencies.

In an embodiment, the pulse train 300 includes frequency pulses 302, 304, 306, 308 in a frequency range of 76 GHz to 76.5 GHz. For example, the modulator 220 of the ranging system 200, as shown in FIG. 2, is operable to apply frequency pulses in a frequency range of 76 GHz to 76.5 GHz to generate the pulse train 300. As shown, the pulse 304 has a highest frequency and the pulse 306 has a lowest frequency. Moreover, the pulses 302 and 308 have associated frequencies that are intermediate between the frequencies of the pulses 304 and 306. The individual frequencies exhibited by the pulse train 300 define a specific code for the digitally signed continuous wave. Moreover, each of the pulses 302, 304, 306, 308 is optionally associated with a time period in a range of 2 μsec to 50 μsec, more optionally with a time period of about 10 μsec. Such implementation of the pulses 302, 304, 306, 308 allows the ranging system 200 of the present disclosure to be operable with a low performance PLL (not shown) as each of the pulses 302, 304, 306, 308 is associated with a time period of about 10 μsec, in contradistinction to typically 100 cycle chirp signals that are used for conventional interrogating radiation.

Although, the pulse train 300 is shown to include frequency pulses 302, 304, 306, 308 in a frequency range of 76 GHz to 76.5 GHz, it will be appreciated that frequency pulses ranging optionally include higher or lower frequency limits. For example, the frequency pulses ranging for the pulse train 300 are optionally in a frequency range of 76 GHz to 76.25 GHz, or in a frequency range of 76 GHz to 77 GHz.

The ranging system 200, elucidated in the foregoing with reference to FIGS. 2 and 3, is capable of being used in many fields of application, for example:
(i) for on-vehicle radar systems, for example for automatic vehicle braking systems and/or automatic vehicle steering systems;
(ii) for monitoring safety-critical areas, for example railway level-crossings;
(iii) for intruder alarm systems, for example for detecting unauthorized personnel;
(iv) for airborne projectile guidance, for example high-velocity guided mortars;
(v) for obstacle detection in automated agricultural equipment, for example automated combine harvesters, ploughing equipment, automated fruit picking apparatus, and so forth;
(vi) for use on harbour (harbor; US English) facilities, for example for guiding automated equipment for handling ship containers; and so forth.

In one embodiment, the processor 270 of the ranging system 200 is further adapted to employ space-time adaptive processing. As aforementioned, the ranging system 200 is optionally employed on a moving platform, such as an on-vehicle radar system); particularly, in such a situation, the processor 270 is adapted to employ space-time adaptive processing. In other words, operating parameters of the processor 270 of the ranging system 200 are varied depending a nature of signals being received in operation from a region of interest (ROI), in an adaptive manner; for example, when the ranging system 200 is vehicle-mounted, varying road conditions in front of a vehicle can vary in complexity when driving from a rural road environment into a complex urban road environment or a complex motorway road environment (for example, a nature of the signature can be varied depending upon changes in the region of interest (ROI)). The space-time adaptive processing enables signal component arising from clutter within the region of interest can be filtered away; such clutter is potentially caused by ground reflections; such filtering enables range data to be extracted pertaining to moving objects with respect to a moving platform (for example a road vehicle chassis, airframe or similar) that is employed with the ranging system 200. The space-time adaptive processing enables order-of-magnitude sensitivity improvements for range detection to be achieved. Moreover, the processor 270 is operable to determine, namely to compute, a velocity of the object 240 from the correlation performed between the reflected continuous wave 242 and the emitted digitally signed continuous wave 232 according to the digital signature, for example by using Doppler detection.

Referring next to FIG. 4, there is shown an illustration of steps of a method 400 of resolving range ambiguity. Specifically, the method 400 includes steps involved in the operation of a ranging system, such as the ranging system 200 elucidated in the foregoing with reference to FIGS. 2 and 3.

At a step 402, a continuous wave is generated.

At a step 404, a digital signature is applied to the continuous wave from the step 402.

At a step 406, the digitally signed continuous wave generated in the step 404 is emitted as interrogating radiation from a transmitter towards an object.

At a step 408, a portion of the emitted continuous wave, namely a portion of the interrogating radiation, is received at a receiver after reflection from the object.

At a step 410, the portion of the reflected continuous wave is correlated against the emitted digitally signed continuous wave according to the digital signature.

At a step 412, an elapsed time period is determined between emitting the interrogating radiation and receiving a reflection of the interrogating radiation.

At a step 414, the range of the object from the transmitter is calculated from the elapsed time period and frequency of the continuous wave.

The steps 402 to 414 are only illustrative and other alternatives can also be provided where one or more steps are added, one or more steps are removed, or one or more steps are provided in a different sequence without departing from the scope of the claims of the present disclosure. For example, the method 400 further includes employing space-time adaptive processing. Moreover, the method 400 includes determining a velocity of the object from the correlation using Doppler detection. The application of the digital signature further includes forming a specific code. In an example, the application of the digital signature on the continuous wave includes application of a frequency shift waveform. Alternatively, the application of the digital signature on the continuous wave includes application of discrete frequency modulation steps, namely frequency modulation applied in a step-wise manner. In an example, the application of the digital signature includes application of frequency pulses in a frequency range of 76 GHz to 76.5 GHz. Moreover, the application of the digital signature includes application of frequency pulses exhibiting individual distinct frequencies. Furthermore, the application of the digital signature includes application of a frequency shift waveform exhibiting non-linearity. Moreover, the correlation of the reflected continuous wave against the emitted digitally signed continuous wave includes correlation over an entire pulse train of the emitted digitally signed continuous wave.

According to another aspect, the present disclosure further provides a computer program product comprising a non-transitory computer-readable storage medium having computer-readable instructions stored thereon, the computer-readable instructions being executable by a computerized device comprising processing hardware to execute the method 400 described hereinabove.

Optionally, the ranging system 200 applies the digital signature to the continuous wave to generate then interrogating radiation that is emitted towards the region of interest (ROI), such that the ranging system 200, for subsequent interrogations of the region of interest (ROI) adaptively modifies the digital signature as a function of range and/or velocity information determined from the portion of the interrogating radiation after reflection from an object in the region of interest (ROI). Such modification of the digital signature includes at least one of:
(a) adaptively modifying a length of the digital signature, for example by modifying a total number of step-wise frequency changes employed for the digital signature when employed in the ranging system 200;
(b) adaptively modifying magnitudes of frequency changes for step-wise frequency changes associated with the digital signature, for example by scaling the frequency changes from one step to another in the digital signature when employed in the ranging system 200; and
(c) adaptively reversing an order of frequency changes of the digital signature employed in the ranging system 200.

Such modification of the digital signature is capable of modifying selectivity or object discrimination of the ranging system 200, when in operation, when interrogating the region of interest (ROI).

It will be appreciated that if a single target were included in a clutter-free environment, a correlator of the ranging system 200 would be able, with relative ease, to estimate a range of the single target and its associated Doppler characteristics. However, if the aforementioned environment were a dense target scenario, or there were a plurality of targets obscured by clutter, for example various forms of round reflection of radar radiation, then a processor capable of providing a sophisticated tracking framework would be advantageously employed in the ranging system 200, when implementing embodiments of the present disclosure.

Modifications to embodiments of the present disclosure described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. A method (400) of resolving range ambiguity in a ranging system (200), wherein the method comprises:
(i) generating a continuous wave;
(ii) applying a digital signature to the continuous wave to generate a digitally-signed continuous wave (232);
(iii) emitting the digitally-signed continuous wave (232) from a transmitter (230) of the ranging system (200) as interrogating radiation towards an object (240);
(iv) receiving at a receiver (250) a portion of the interrogating radiation after reflection from the object (240);
(v) correlating the portion of the interrogating radiation (242) against the emitted digitally signed continuous wave (232) according to the digital signature;
(vi) determining from correlation in (v) an elapsed time period between emitting the interrogating radiation and receiving the portion of the interrogating radiation after reflection from the object (240);
(vii) from the elapsed time period and a frequency of the continuous wave, calculating a range of the object (240) from the transmitter (230), employing space-time adaptive processing; and
(viii) determining a velocity of the object (240) from correlation in (v) using Doppler detection.

2. The method (400) of claim 1, wherein applying the digital signature further comprises applying a frequency shift waveform.

3. The method (400) of claim 1, wherein applying the digital signature further comprises applying discrete frequency modulation steps.

4. The method (400) of claim 1, wherein applying the digital signature further comprises applying frequency pulses in a frequency range of 76 GHz to 76.5 GHz.

5. The method (400) of claim 1, wherein applying the digital signature further comprises applying frequency pulses exhibiting individual frequencies.

6. The method (400) of claim 1, wherein applying the digital signature further comprises applying a frequency shift waveform exhibiting non-linearity.

7. The method (400) of claim 1, wherein applying the digital signature further comprises forming a specific code.

8. The method (400) of claim 1, wherein correlating further comprises correlating over an entire pulse train (300) of the emitted digitally signed continuous wave (232).

9. The method (400) of claim 1, wherein the method further comprises at least one of:
(a) adaptively modifying a length of the digital signature, for example by modifying a total number of step-wise frequency changes employed for the digital signature when employed in the ranging system (200);
(b) adaptively modifying magnitudes of frequency changes for step-wise frequency changes associated with the digital signature, for example by scaling the frequency changes from one step to another in the digital signature when employed in the ranging system (200); and
(c) adaptively reversing an order of frequency changes of the digital signature employed in the ranging system (200).

10. A system (200) for resolving range ambiguity, wherein the system (200) comprises:
(i) a wave generator for generating a continuous wave, and a modulator for applying a digital signature to the continuous wave to generate a digitally-signed continuous wave (232);
(ii) a transmitter (230) for emitting the digitally-signed continuous wave (232) from the ranging system (200) as interrogating radiation towards an object (240);
(iii) a receiver (250) for receiving a portion of the interrogating radiation after reflection from the object (240);
(iv) a correlator for correlating the portion of the interrogating radiation (242) against the emitted digitally signed continuous wave (232) according to the digital signature;
(vi) a processor for determining from correlation in the correlator an elapsed time period between emitting the interrogating radiation and receiving the portion of the interrogating radiation after reflection from the object (240); wherein the processor, from the elapsed time period and a frequency of the continuous wave, is operable to calculate a range of the object (240) from the transmitter (230) by employing space-time adaptive processing; and to determine a velocity of the object (240) from correlation in the correlator using Doppler detection.

11. The system of claim 10, wherein the modulator (220) is further configured to apply a frequency shift waveform.

12. The system of claim 10, wherein the modulator (220) is further configured to apply discrete frequency modulation steps.

13. The system of claim 10, wherein the modulator (220) is further configured to apply frequency pulses in a frequency range of 76 GHz to 76.5 GHz.

14. The system of claim 10, wherein the modulator (220) is further configured to apply frequency pulses exhibiting individual frequencies.

15. The system of claim 10, wherein the modulator (220) is further configured to apply a frequency shift waveform exhibiting non-linearity.

16. The system of claim 10, wherein the modulator is further configured to form a specific code.

17. The system of claim 10, wherein the correlator (260) is further configured to correlate over an entire pulse train (300) of the emitted digitally signed continuous wave (232).

18. A computer program products comprising a non-transitory computer-readable storage medium having computer-readable instructions stored thereon, the computer-readable instructions being executable by a computerized device comprising processing hardware configured to execute a method as claimed in claim 1.
